(19) United States
(12) Patent Application Publication
(10) Pub. No.: US 2014/0108244 A1
(43) Pub. Date: Apr. 17, 2014

(54) MEDIA HANDLING DEVICE REJECT RATE

(71) Applicant: BANK OF AMERICA, Charlotte, NC (US)

(72) Inventors: Matthew Kristofer Bryant, Gastonia, NC (US); Kristy M. Crist, Charlotte, NC (US); Aaron Drago, Charlotte, NC (US); Devin D. Rhodes, Lexington, KY (US)

(73) Assignee: Bank of America, Charlotte, NC (US)

(21) Appl. No.: 13/649,623

(22) Filed: Oct. 11, 2012

(51) Int. Cl. G06Q 40/02

(52) U.S. Cl. 705/43

(57) ABSTRACT

A system and method of providing reject rate data and monitoring media handling device performance related to the reject rate data is disclosed, wherein the media handling device may be an automated teller machine. The system and methods may include determining a reject rate; analyzing a set of reject rate data for trending and statistical comparative analysis; transferring the set of reject rate data from one or more ATMs; and loading the set of rejection rate data into a data warehouse. The method may further include analyzing the set of reject rate data for trending and statistical comparative analysis to gain insight and make improvements to the customer experience at the ATM. The method may further include providing predictive fault tracing to predict in advance when the ATM needs maintenance.

### BACKGROUND

The increased use of media handling devices, which include automated teller machines (ATMs), may result in additional malfunctions and/or service calls. In accordance with aspects of this invention, other types of media handling devices may include vending machines, coin counting devices and/or machines, DVD dispensing devices and/or machines, and other similar-type devices or machines. For these media handling devices, the media reject rates are a high contributing factor for failed customer interactions. For ATMs specifically, the cash and check reject rates in ATMs are a high contributing factor for all ATM failed customer interactions. Of surveyed customers that experienced a problem at the ATM, “ATM Rejected/spit out my cash” and “ATM Rejected/spit out my check” are repeatedly the most common responses. The effort to collect, process, and provide results for a method to better understand the customer impact of rejected cash and check deposits is a manual process with several risks. There is a large chance that data from these machines will be partially lost from the month during the process of collecting the data or during routine machine maintenance. Also, due to the fact that this process only accounts for a minimal amount of the ATM fleet's performance, there could be poor performing machines that are not monitored. Accordingly, a system and method of establishing a process of monitoring ATM performance related to reject rate enhances the ability to better understand the customer experience and make targeted improvements. Additionally, a system and method of establishing a process of monitoring a media deposit machine performance related to reject rate enhances the ability to better understand the customer experience and make targeted improvements.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

According to one or more aspects, a method of providing reject rate data and monitoring ATM performance related to the reject rate data that may include the steps of: 1) receiving a deposit (cash or check) into an ATM depository (cash or check), wherein the cash or check items deposited are either accepted or rejected into the ATM depository; 2) if the deposited item is rejected, ejecting the deposited item from the ATM depository; 3) determining, by a processor, a reject rate determined from total number of rejected deposit items divided by the total number of processed deposit items; 4) analyzing, by a processor, a set of reject rate data for trending and statistical comparative analysis, wherein the set of reject rate data is consolidated from multiple reject rates. The method may further include the step of: providing, by a processor, predictive fault tracing to predict in advance when the ATM needs maintenance. The set of reject rate data may be collected for an ATM fleet. Additionally, the set of reject rate data may be collected daily from the ATM fleet.

In another aspect of the invention, the analyzing step may include one or more of the following statistical tools: significance testing, hypothesis testing, ANOVAs, regression analysis, and control charting over time. The trending and statistical comparative analysis may provide pre-emptive scheduling for maintenance. The trending and statistical comparative analysis may provide a comparison of vendors, models, or like characteristics for a group of ATMs for identifying possible opportunities for improved performance. The trending and statistical comparative analysis may provide a means for identifying individual ATMs exhibiting poor performance

In another aspect of the invention, a method of providing reject rate data and monitoring ATM performance related to the reject rate data, wherein the method may include the steps of: 1) transferring a set of rejection rate data from one or more ATMs, wherein the reject rate data is defined as the number of item rejections divided by the number of items processed at an ATM; 2) loading the set of rejection rate data into a data warehouse; 3) transforming, by a processor, the set of rejection rate data within the data warehouse into a format that can be analyzed and statistically compared; and 4) displaying, on a display connected to the processor, the set of rejection rate data. The method may further include the step of: providing, by a processor, predictive fault tracing to predict in advance when the ATM needs maintenance.

In another aspect of the invention, the method may further include the step of: analyzing, by a processor, the set of reject rate data for trending and statistical comparative analysis. The analyzing step may include one or more of the following statistical tools: significance testing, hypothesis testing, ANOVAs, regression analysis, and control charting over time. The trending and statistical comparative analysis provides pre-emptive scheduling for maintenance. The trending and statistical comparative analysis may provide a comparison of old software versus new software installations for the ATM. The trending and statistical comparative analysis may provide a comparison of old hardware versus new hardware installations for the ATM. The trending and statistical comparative analysis may provide a comparison of vendors, models, or any like characteristics for a given group of ATMs.

In another aspect of the invention, a method of providing reject rate data and monitoring ATM performance related to the reject rate data, where the method may include the steps of: 1) receiving a deposit into an ATM depository, wherein the deposit is either accepted or rejected at the ATM depository; 2) if the deposit is rejected, ejecting the deposit from the ATM depository; 3) determining, by a processor, a reject rate determined from total number of rejected deposited items divided by the total number of processed deposited items; 4) analyzing, by a processor, a set of reject rate data for trending and statistical comparative analysis, wherein the set of reject rate data is consolidated from multiple reject rates; 5) transferring the set of reject rate data from one or more ATMs; 6) loading the set of rejection rate data into a data warehouse; 7) transforming, by a processor, the set of rejection rate data within the data warehouse into a format that can be analyzed and statistically compared; and 8) displaying, on a display connected to the processor, the set of rejection rate data. The method may also include the step of analyzing, by a processor, the set of reject rate data for trending and statistical comparative analysis. The method may further include the step of providing, by a processor, predictive fault tracing to predict in advance when the ATM needs maintenance.

### BRIEF DESCRIPTION OF THE DRAWINGS

The present disclosure is illustrated by way of example and not limited in the accompanying figures in which like reference numerals indicate similar elements.

FIG. 1 illustrates an example of a suitable operating environment in which various aspects of the disclosure may be implemented.

FIG. 2 illustrates an example ATM environment according to one or more aspects described herein.

FIG. 3 illustrates another example ATM environment according to one or more aspects described herein.

FIG. 4 illustrates an example method of providing reject rate data and/or information and monitoring ATM performance related to the reject rate data according to one or more aspects described herein.

FIG. 5 illustrates another example method of providing reject rate data and/or information and monitoring ATM performance related to the reject rate data according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

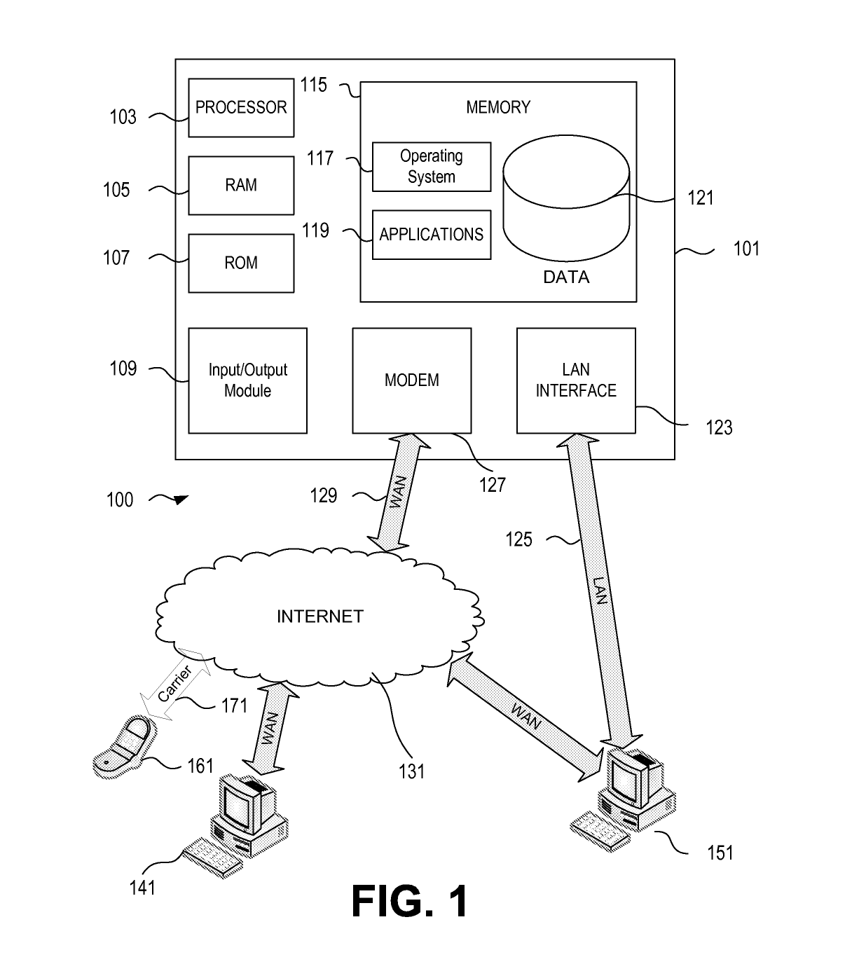

FIG. 1 illustrates a block diagram of a generic computing device 101 (e.g., a computer server) in computing environment 100 that may be used according to an illustrative embodiment of the disclosure. The computer server 101 may have a processor 103 for controlling overall operation of the server and its associated components, including random access memory (RAM) 105, read-only memory (ROM) 107, input/output (I/O) module 109, and memory 115. According to aspects of the invention, the computing environment 100 may represent any media handling device such as ATM deposit systems, ATM rejection systems, and/or ATM rejection rate systems, or any combination thereof. ATM deposit systems 100 will be used throughout which will generally define system and/or processing system as described above as the computing environment 100 to perform the various methods and processes according to the invention as described below.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. In accordance with aspects of this invention, the associated database may be defined as an ATM centralized database 121 or database warehouse 121. Alternatively, some or all of server 101 computer executable instructions may be embodied in hardware or firmware (not shown).

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 may be connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks) including various other components, such as a battery, speaker, and antennas (not shown). The service computing devices 141 and 151 may be personal computing devices or servers that include many or all of the elements described above relative to the computing device 101. Service computing device 161 may be a mobile device communicating over wireless carrier channel 171, for example as may be utilized and/or carried by a service technician during a service call.

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, and/or data structures that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

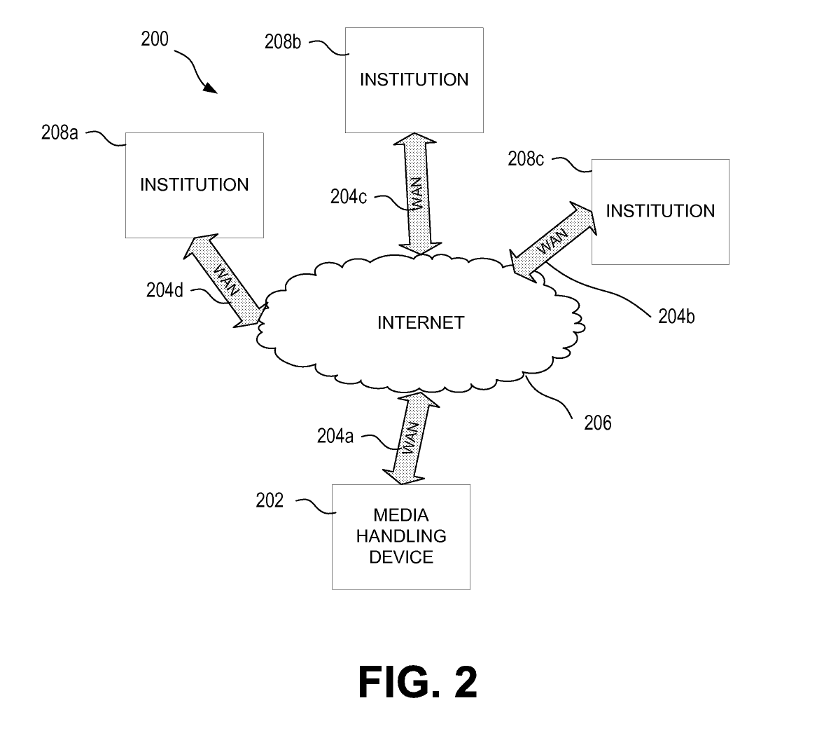

The systems, devices, and/or networks of FIG. 1 may, in one or more arrangements, be used to provide functionality to one or more media (e.g. cash, check) handling devices, such as an automated teller machine (ATM) 202. Other media handling devices may include vending machines, coin counting devices or machines, DVD dispensing devices or machines, and other similar-type devices or machines. For ATMs specifically, ATMs 202 are commonly used to provide access to financial transactions without requiring an individual, such as a bank teller, to complete the transaction. ATMs 202 are often associated with one or more financial institutions, however, typical ATMs 202 are accessible to both customers of the associated financial institution and non-customers, sometimes for a fee. One example ATM environment 200 is shown in FIG. 2. The ATM 202 is connected, via WAN and/or LAN 204a-204d to a network 206, such as the Internet, to communicate with one or more financial institutions 208a-208c. One of financial institutions 208a-208c, such as financial institution 208a, may be associated with the ATM 202 while the others, such as financial institutions 208b, 208c may not be associated with the ATM 202 but may communicate with the ATM 202 to complete transactions by customers associated with the financial institutions 208b, 208c and conducted at the ATM 202.

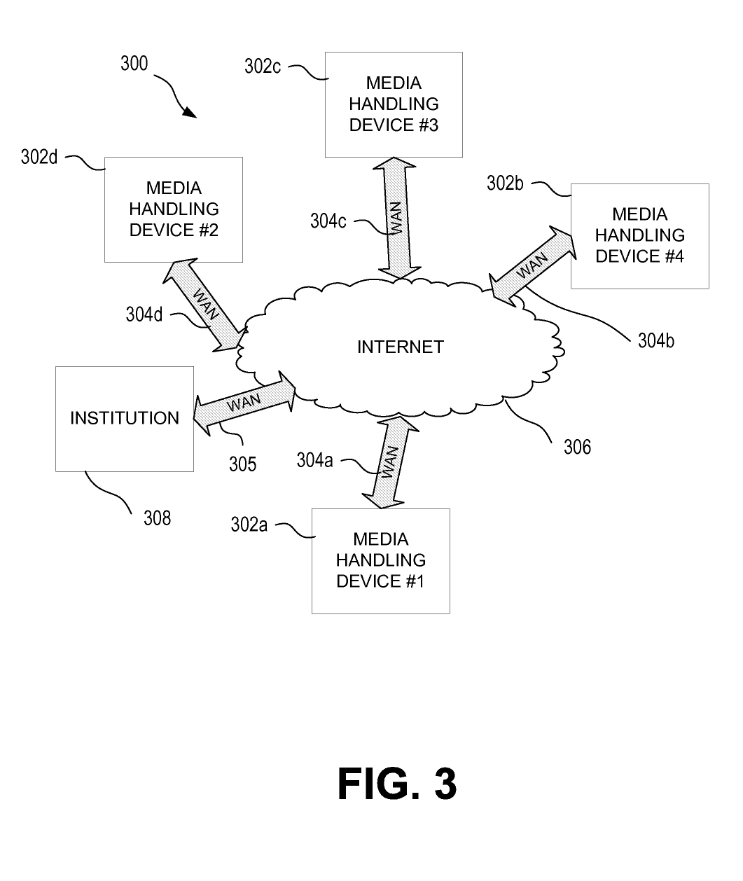

In some instances, a financial institution may have several ATMs. For instance, FIG. 3 illustrates one example computing environment in which a plurality of ATMs 302a-302d are in communication with each other (such as via WAN 304a-304d) via a network 306, such as the Internet. Further, the financial institution 308 with which the ATMs 302a-302d are associated may also be connected to the network 306, such as via WAN 305 to permit communication between each ATM and the financial institution. In some examples, the status of one or more ATMs 302a-302d, capacity available at one or more ATMs 302a-302d, and/or maintenance status of one or more ATMs 302a-302d, may be communicated to or known by other ATMs 302a-302d and/or the financial institution.

In an aspect according to this invention, apparatus, methods, or processes may be provided to implement an automated monitoring system that provides a reject rate and reject rate results for media handling device, such an ATM 202 continuously. Additionally, the apparatus, methods, or processes may be provided to implement an automated monitoring system that provides a reject rate for all of the media handling devices, such as ATMs 202, from an organization. Additionally, in an aspect of this invention, the apparatus, methods, or processes may continually improve a reject rate by utilizing different methodologies and rules such as statistical process control and close loop corrective action. Additionally, in another aspect of this invention, the apparatus, methods, or processes may provide a visibility to the entire fleet of ATMs 202, which will work to understand the process capability for each validator type and work to provide continuous improvement. Additionally, the apparatus, methods, or processes of the present invention may provide a design and implement a robust measurement system to enable monitoring the reject rate for all machines in the ATM fleet 202 every day including the automated data collection process, data storage site, and reporting structure of this data.

Media handling devices generally accept deposits from customers. Those media handling devices may sometimes reject the items. The remaining description will detail the use of ATMs and cash and/or checks as the media. It should be understood that any media handling device may be utilized and substituted throughout the remainder of the description of this invention, wherein the items that are deposited and accepted being utilized as the media. For example, with ATMs, ATMs 202 generally accept deposits from customers. ATMs 202 may sometimes reject the items, such as perfectly acceptable cash or checks. This can be bothersome to the customers and provides poor customer service to the customer. In an aspect of the invention, an ATM reject rate system 100 may be provided to gain the visibility at the ATM 202 of how many items (which may include all forms of cash, dollar bills in all denominations, other such notes, and checks) the machine is accepting and how many items the machine is rejecting. The ATM deposit system 100 may include a processor, and other components as described above and as illustrated in FIG. 1. Based on this determination, a reject rate may be determined by dividing the total items rejected by the total items received. Said another way, the total items processed may equal the total items rejected plus the total items accepted. The ATM deposit system 100 may be provided to not only gather the data and determine the reject rate for an ATM 202, but also transfer the data to a data warehouse 121.

In another aspect of this invention, the ATM deposit system 100 may be utilized to improve the performance of ATMs 202. For example, the ATM deposit system 100 may provide predictive measures that may be utilized to analyze and review the reject rate data from the ATMs 202. For a group of ATMs 202, the predictive measures may be utilized to provide characteristics for the entire group of ATMs 202 that may need updating in order to improve the reject rate of the entire group of ATMs 202. For individual ATMs 202, the predictive measures may be utilized for reporting for potential maintenance or service-related reasons.

In another aspect of this invention, the ATM reject deposit 100 may be utilized to provide predictive fault tracing. The ATM deposit system 100, utilizing the reject rate information from the ATMs 202, may predict in advance when an ATM 202 may need maintenance or may need service. For example, the ATM deposit system 100 may provide a notification based on how the ATM 202 is able to accept items on whether or not the ATM 202 needs maintenance or service.

In an aspect of the invention, the ATM deposit system 100 may perform this predictive fault tracing by analyzing the individual ATM 202 and comparing the historical data of that individual ATM 202 for the reject rate. For example, if the reject rate for the ATM 202 begins to trend upward, the ATM deposit system 100 may sense or predict a possible fault in that ATM 202. In another aspect of this invention, the ATM deposit system 100 may perform this predictive fault tracing by analyzing the reject rate information of that individual ATM 202 as compared to other ATMs 202. For example, if the reject rate of that individual ATM 202 trends higher than the reject rate of the other ATMs 202 in the area or the other like characteristics of ATMs 202, then the ATM deposit system 100 may sense or predict a possible fault in that individual ATM 202.

This ability to proactively detect degraded performance may be utilized for other machines without departing from this invention. For example, this predictive detection may be utilized by check depositors, vending machines, and other such similar machines that accept media. Many different parts or areas of the deposit receiving section of the ATM 202 may be providing the degraded performance. For example, the degraded performance may be caused by jams, shutters not working, mechanical instruments that are not being met, and/or scanners not working correctly. Other causes may be included without departing from this invention.

In another aspect of the invention, the ATM deposit system 100 and/or the data warehouse 121 may provide analytical tools. Generally, the analytical tools may provide a means to analyze how the ATMs are performing against each other and how they are performing as compared to historical values. For example, the ATM deposit system 100 and/or the data warehouse 121 may provide trending and/or statistical comparative analysis of the reject rate information from the ATMs 202. The reject rate information may be collected by all ATMs 202 in a fleet, or multiple ATMs in the fleet. The reject rate information may be collected daily, multiple times a day, or multiple times per week, without departing from this invention. The trending and/or statistical comparative analysis of the reject rate information from the ATMs 202 may provide analysis of different types of machines or models, trending over time, outlier identification. Additionally, the trending and/or statistical comparative analysis of the reject rate information from the ATMs 202 may provide information about individual poor performing ATMs 202 or even ATM with like characteristics (e.g. models, hardware characteristics, software versions, location) that perform poorly. The trending and/or statistical comparative analysis of the reject rate information from the ATMs 202 may further provide chronic statistical comparative analysis, such as before and after ATM updates (e.g. software, firmware, hardware). The trending and/or statistical comparative analysis of the reject rate information from the ATMs 202 may further provide chronic statistical comparative analysis, such as before and after servicing, such as providing information on whether the technician was effective for targeting servicing or for other issues. The trending and/or statistical comparative analysis of the reject rate information from the ATMs 202 may include but not be limited to significance testing, hypothesis testing, ANOVAs, regression analysis, control charting over time, and other similar statistical analysis tools.

In another aspect of the invention, the trending and/or statistical comparative analysis of the reject rate information from the ATMs 202 may provide pre-emptive scheduling maintenance. For example, maintenance or servicing may be scheduled for any of the deposit receiving unit components when a technician may be scheduled to be on site to perform other maintenance procedures. Additionally, the maintenance or servicing may be automated, such that certain reject rate thresholds may trigger or generate a dispatch or a technician to provide service or maintenance for a given ATM 202 or group of ATMs.

In another aspect of the invention, the trending and/or statistical comparative analysis of the reject rate information from the ATMs 202 may provide comparisons against various different important items for the ATMs 202. For example, the trending and/or statistical comparative analysis of the reject rate information from the ATMs 202 may provide a comparison of old software vs. new software installations. Additionally, the trending and/or statistical comparative analysis of the reject rate information from the ATMs 202 may provide a comparison of old hardware or components vs. new hardware or components. Furthermore, the trending and/or statistical comparative analysis of the reject rate information from the ATMs 202 may provide a comparison of different vendors or different models of ATMs 202. The trending and/or statistical comparative analysis of the reject rate information from the ATMs 202 may provide a comparison of any like characteristics for the group of ATMs 202.

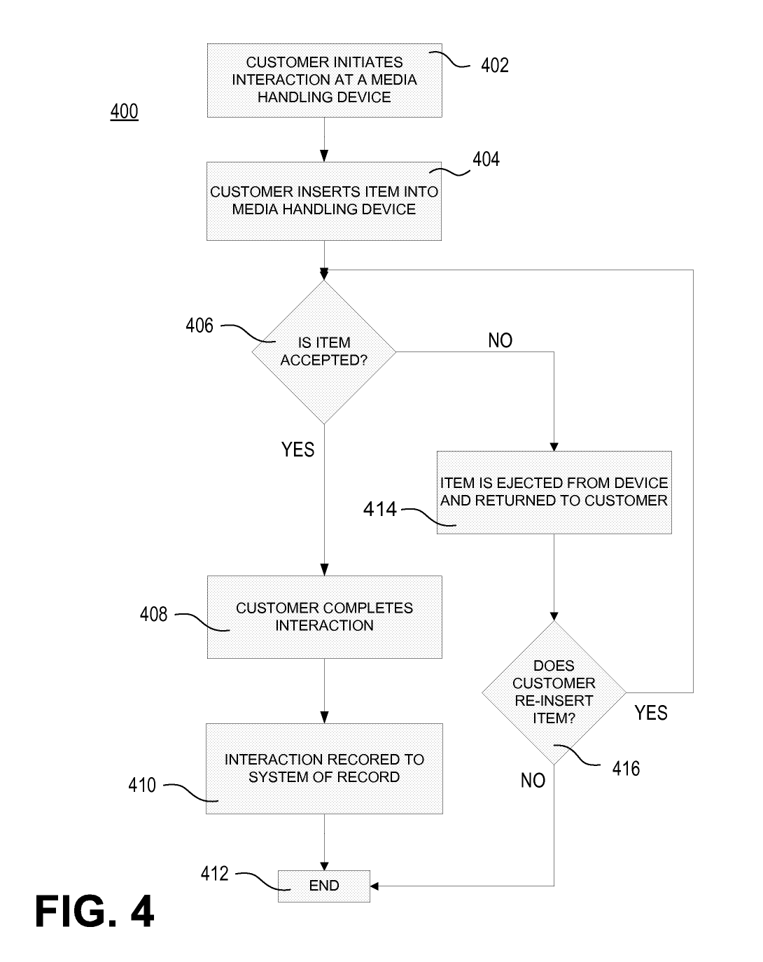

FIG. 4 illustrates one example method of providing reject rate data and/or information and monitoring a media handling device performance related to the reject rate data according to aspects of this invention described herein. For the below description, ATM will be listed, but all media handling devices may be utilized in place of the ATM in accordance with aspects of this invention. The method of providing reject rate information in accordance with FIG. 4 may be performed by an ATM deposit system 100 and/or a data warehouse 121. The ATM deposit system 100 and the data warehouse 121 may work independently or in conjunction with one another. In step 402, a customer may initiate an interaction at a media handling device or a deposit at the ATM 202. Generally, the customer makes a selection for deposit while at the ATM 202. In step 404, a customer inserts an item into the media handling device or cash or a check into an ATM depository. During this step 404, the ATM 202 or ATM deposit system 100 may receive the media. The item may move through an infeed module into the ATM depository. The ATM deposit system 100 may scan or sense the items being fed into the ATM depository. The ATM deposit system 100 may then count those items as “processed.”

FIG. 4 further illustrates in a step 406, the media handling device may accept the item or the ATM deposit system 100 may either accept the item for deposit or not accept (or reject) the item for deposit. There may be various reasons why the ATM deposit system 100 may reject the item for deposit. First, the item may have not been scanned properly because of how it was input by the customer. The item may also be rejected by the ATM deposit system 100 when there are malfunctions or faults in the equipment in the ATM 202. For example, the rejection of the item may be caused by, but not limited to, jams, shutters not working, mechanical instruments that are not being met, and/or scanners not working correctly.

If the ATM deposit system 100 accepts the item for deposit, the item is counted as “accepted” in the ATM deposit system 100 and the data warehouse 121. Additionally, if the ATM deposit system 100 rejects the item for deposit, the item is counted as “rejected” in the ATM deposit system 100 and the data warehouse 121. As was described above, the ATM deposit system 100 may then determine a reject rate based on the items counted as “accepted” and the items counted as “rejected.” The ATM deposit system 100 may determine the reject rate as the “rejected” items divided by the total number of processed items (which equals the “accepted” items plus the “rejected” items).

Following step 406, the media handling device or the ATM deposit system 100 may either accept or reject the item for deposit. If the ATM deposit system 100 accepts the item for deposit, step 408 follows. In step 408, the customer completes the interaction at the media handling device or the deposit at the ATM 202. Further, in step 410, the interaction may be recorded to the system of record or the ATM 202 and the ATM processing system may deposit the amount of the deposit into the customer's account. In step 412, the method and the transaction may be complete.

If the media handling device or the ATM deposit system 100 rejects the item for deposit, step 414 follows. In step 414, the media handling device or the ATM ejects the item from the device or the ATM to the customer. When the ATM ejects the item from the ATM 202 to the customer, the ATM deposit system 100 counts those items as “rejected.”

In step 416, the customer may then decide to re-insert the item again or not re-insert the item. If the customer re-inserts the item, then the process or method returns to step 406, to determines if the ATM deposit system 100 accepts the re-inserted items and follows on as described above. If the customer decides not to reinsert the item at step 416, then step 412, wherein the method and transaction are complete.

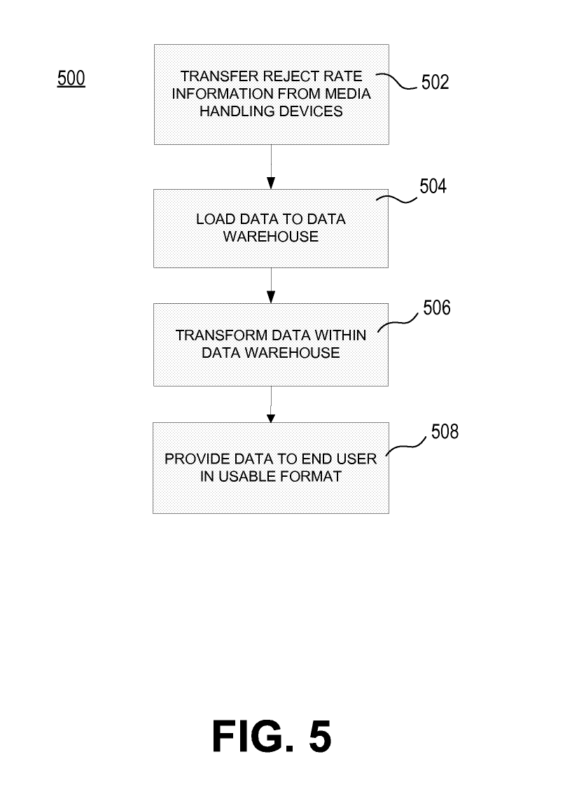

FIG. 5 illustrates another example method of providing reject rate data and/or information and monitoring media handling device and/or ATM performance related to the reject rate data according to aspects of this invention described herein. The method of providing reject rate information in accordance with FIG. 5 may be performed by an ATM deposit system 100 and/or database warehouse 121. The ATM deposit system 100 and the data warehouse 121 may work independently or in conjunction with one another. In step 502, an ATM deposit system 100 may transfer a set of rejection rate data from the ATMs 202. The ATM deposit system 100 may transfer the set of rejection rate data from one ATM 202 or multiple ATMs 202. In a step 504, the set of rejection rate data may be loaded into a data warehouse 121. In a step 506, the set of rejection rate data may be transformed within the data warehouse 121 to a useable format and/or a format that is capable of being analyzed and statistically compared. In a step 508, the set of rejection rate data may then be displayed to an end user in a useable format. The set of rejection rate data may be displayed for example on a video display device connected to the ATM deposit system 100, data warehouse 121, or graphical user interface for providing textual, audiovisual and/or graphical output.

Furthermore in these steps as illustrated in FIG. 5, the ATM deposit system 100 and the data warehouse 121 may provide other functions and steps without departing from this invention. In an aspect of this invention, the ATM deposit system 100, the data warehouse may provide predictive measures that may be utilized to analyze and review the reject rate data from the ATMs 202. In another aspect of this invention, the ATM deposit system 100 and the data warehouse may provide predictive fault tracing. The ATM deposit system 100, utilizing the reject rate data from the ATMs 202, may predict in advance when an ATM 202 may need maintenance or may need service.

In another aspect of this invention, the ATM deposit system 100 and the data warehouse may provide analytical tools. Generally, the analytical tools may provide a means to analyze how the ATMs are performing against each other and how they are historically performing. For example, the ATM deposit system 100 and/or the data warehouse 121 may provide trending and/or statistical comparative analysis of the reject rate data from the ATMs 202. The reject rate data may be collected by all ATMs 202 in a fleet, or multiple ATMs in the fleet, and collected daily, multiple times a day, or multiple times per week.

The trending and/or statistical comparative analysis of the reject rate data from the ATMs 202 may provide analysis of different types of machines, models, or other like characteristics, trending over time, outlier identification. Additionally, the trending and/or statistical comparative analysis of the reject rate data from the ATMs 202 may provide information about individual poor performing ATMs 202 or even ATM groups that perform poorly. The trending and/or statistical comparative analysis of the reject rate data from the ATMs 202 may further provide chronic statistical comparative analysis, such as before and after any ATM update (e.g. software, firmware, hardware updates). The trending and/or statistical comparative analysis of the reject rate data from the ATMs 202 may further provide chronic statistical comparative analysis, such as before and after servicing, and further such as providing information on whether the technician was effective for targeting servicing or for other issues. The trending and/or statistical comparative analysis of the reject rate data from the ATMs 202 may include but not be limited to significance testing, hypothesis testing, ANOVAs, control charting over time, and other similar statistical analysis tools.

In another aspect of this invention, the ATM deposit system 100 and data warehouse 121 may provide a trending and/or statistical comparative analysis of the reject rate data from the ATMs 202 that may provide pre-emptive scheduling maintenance.

In another aspect of this invention, the ATM deposit system 100 and the data warehouse 121 may provide a trending and/or statistical comparative analysis of the reject rate data from the ATMs 202 that may provide comparisons against various different important items for the ATMs 202. For example, the trending and/or statistical comparative analysis of the reject rate data from the ATMs 202 may provide a comparison of old software vs. new software installations. Additionally, the trending and/or statistical comparative analysis of the reject rate data from the ATMs 202 may provide a comparison of old hardware or components vs. new hardware or components. Furthermore, the trending and/or statistical comparative analysis of the reject rate data from the ATMs 202 may provide a comparison of different vendors of different models of ATMs 202. The trending and/or statistical comparative analysis of the reject rate information from the ATMs 202 may provide a comparison of any like characteristics for the group of ATMs 202.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

1. A method of providing reject rate data and monitoring ATM performance related to the reject rate data, the method comprising:
receiving a deposit into an ATM depository of a first ATM, wherein the deposit is either accepted or rejected into the ATM depository;
if the deposit is rejected, ejecting the deposit from the ATM depository;
determining, by a computer processor, a reject rate determined from total number of rejected deposits divided by the total number of processed deposits;
analyzing, by the computer processor, a set of reject rate data for trending and statistical comparative analysis of the first ATM in comparison with a second ATM in a same geographic area, and in comparison with historical performance values, wherein the set of reject rate data is consolidated from multiple reject rates; and
pre-emptive scheduling of maintenance of the first ATM based on a trending higher rejection rate of the first ATM when compared to the second ATM.

2. The method of claim 1, wherein the set of reject rate data is collected for an ATM fleet.

3. The method of claim 2, wherein the set of reject rate data is collected daily from the ATM fleet.

4. The method of claim 1, wherein the analyzing step includes one or more of the following statistical tools: significance testing, hypothesis testing, ANOVAs, and control charting over time.

5. (canceled)

6. The method of claim 1, further comprising:
transforming, by the computer processor, the set of rejection rate data within the data warehouse into a format that can be analyzed and statistically compared.

7. The method of claim 1, further including the step of:
providing, by the computer processor, predictive fault tracing to predict in advance when the ATM needs maintenance.

8. A method of providing reject rate data and monitoring device performance related to the reject rate data, the method comprising:
transferring, by a computer processor, a set of rejection rate data from one or more media handling devices, wherein the set of reject rate data is defined as the number of items rejected divided by the number of items processed at media handling device;
loading, by the computer processor, the set of rejection rate data into a data warehouse;
transforming, by the computer processor, the set of rejection rate data within the data warehouse into a format that can be analyzed and statistically compare old hardware of the one or more media handling devices to new hardware;
displaying, on a display connected to the computer processor, the set of rejection rate data; and
pre-emptively scheduling of maintenance of the one or more media handling devices based on the an indicated upward trend in the rejection rate data.

9. The method of claim 8 further including analyzing, by a processor, the set of reject rate data for trending and statistical comparative analysis.

10. The method of claim 9, wherein the analyzing step includes one or more of the following statistical tools: significance testing, hypothesis testing, ANOVAs, and control charting over time.

11. The method of claim 8, wherein the media handling device is an automated teller machine.

12. (canceled)

13. The method of claim 9, wherein the trending and statistical comparative analysis provides a comparison of a media handling device update including one or more of the following: old software versus new software installations, old hardware versus new hardware installations, old firmware versus new firmware installation.

14. The method of claim 9, wherein the trending and statistical comparative analysis provides a comparison of different group of media handling devices based on a set of characteristics.

15. The method of claim 8, further including the step of:
providing, by a processor, predictive fault tracing to predict in advance when the media handling device needs maintenance.

16. A method of providing reject rate data and monitoring ATM performance related to the reject rate data, the method comprising:
receiving a deposited item into an ATM depository of a first ATM, wherein the deposited item is either accepted or rejected into the ATM depository;
if the deposited item is rejected, ejecting the deposited item from the ATM depository;
determining, by a computer processor, a reject rate determined from total number of rejected deposited items divided by the total number of processed deposited items;
analyzing, by the computer processor, a set of reject rate data for trending and statistical comparative analysis of the first ATM in comparison with a second ATM in the same geographic area, and in comparison with historical performance values, wherein the set of reject rate data is consolidated from multiple reject rates;
transferring, by the computer processor, the set of reject rate data from one or more ATMs;
loading, by the computer processor, the set of rejection rate data into a data warehouse;
transforming, by the computer processor, the set of rejection rate data within the data warehouse into a format that can be analyzed and statistically compared;
displaying, on a display connected to the computer processor, the set of rejection rate data; and
pre-emptively scheduling maintenance of the first ATM based on a trending higher reject rate of the first ATM when compared to the second ATM.

17. The method of claim 16 further including analyzing, by a processor, the set of reject rate data for trending and statistical comparative analysis.

18. The method of claim 16, further including the step of:
providing, by a processor, predictive fault tracing to predict in advance when the ATM needs maintenance.

19. (canceled)

20. (canceled)

21. A system for providing reject rate data and monitoring media handling device performance related to the reject rate data, comprising:
a media handling device, for receiving a deposited item that is either accepted or rejected, wherein the deposited item is ejected from the media handling device if it is rejected;
a non-transitory computer-readable medium comprising computer-executable instructions that when executed by at least one processor cause the at least one processor to perform at least:
determine reject rate data as a total number of deposited items rejected by the media handling device divided by a total number of deposited items processed by the media handling device;
analyze a set of reject rate data for trending and statistical comparative analysis, wherein the set of reject rate data is consolidated from multiple reject rates;
transfer the set of reject rate data from one or more media handling devices;
load the set of rejection rate data into a data warehouse; and
transform the set of rejection rate data within the data warehouse into a format that can be analyzed and statistically compared;
a display, for displaying the set of rejection rate data; and
pre-emptively schedule maintenance based on the trending and statistical comparative analysis of the set of rejection rate data.

22. The system according to claim 21, wherein the non-transitory computer-readable medium further performs predictive fault tracing to predict in advance when the media handling device needs maintenance.
